(19) United States
(12) Patent Application Publication
(10) Pub. No.: US 2025/0288958 A1
(43) Pub. Date: Sep. 18, 2025

(54) WATER TREATMENT FACILITY AND METHOD FOR OPERATING WATER TREATMENT FACILITY

(71) Applicant: KURITA WATER INDUSTRIES LTD., Tokyo (JP)

(72) Inventor: Hirotoki NAKAZATO, Tokyo (JP)

(73) Assignee: KURITA WATER INDUSTRIES LTD., Tokyo (JP)

(21) Appl. No.: 18/860,005

(22) PCT Filed: Apr. 21, 2023
(86) PCT No.: PCT/JP2023/015951

§ 371 Date: Oct. 25, 2024

(30) Foreign Application Priority Data
Apr. 26, 2022 (JP) 2022-072081

(51) Int. Cl. B01D 61/18; B01D 61/14; B01D 61/22; B01D 65/02; C02F 1/00; C02F 1/44

(52) U.S. Cl. CPC B01D 61/18; B01D 61/146; B01D 61/22; B01D 65/02; C02F 1/008; C02F 1/444; B01D 2313/243; B01D 2313/501; B01D 2317/025; B01D 2317/04; B01D 2317/06; B01D 2321/185; C02F 2301/046; C02F 2301/08; C02F 2303/16

(57) ABSTRACT

This water treatment facility comprises: a first membrane filtration device; a second membrane filtration device provided at a stage subsequent to the first membrane filtration device; a reservoir tank that retains a portion of permeated water that has permeated through the first membrane filtration device; a circulation flow path that is provided between the first membrane filtration device and the reservoir tank, and enables the permeated water retained in the reservoir tank to circulate between the first membrane filtration device and the reservoir tank; a pump that is provided in the circulation flow path; and a control unit that controls the pump such that after the end of washing of a filtration membrane accompanied by introduction of air into the first membrane filtration device, the permeated water retained in the reservoir tank is circulated between the first membrane filtration device and the reservoir tank through the circulation flow path.

### TECHNICAL FIELD

The present invention relates to a water treatment facility and a method for operating a water treatment facility.

This application claims the priority benefit of Japan application serial no. 2022-72081, filed on Apr. 26, 2022. The entirety of the above-mentioned patent application is hereby incorporated by reference herein and made a part of this specification.

### DESCRIPTION OF RELATED ART

For example, membrane filtration devices are widely used in fields such as pure water production and wastewater recovery as a means to remove suspended matter components and organic matter. As an example of a membrane filtration device, one described in Patent Literature 1 is known. The filtration membranes used in membrane filtration devices are selected according to the separation target, such as microfiltration membranes (MF membranes) or ultrafiltration membranes (UF membranes), with the former generally having pores of around 0.1 μm and the latter having pores of 0.005 to 0.5 μm.

For example, a water treatment facility equipped with a UF membrane device and an RO membrane device as filtration membrane devices is known. The UF membrane device and RO membrane device are equipped with a UF membrane and an RO membrane, respectively. In the water treatment facility, pure water is produced by first removing suspended matter components from the raw water using the UF membrane, and then performing desalination using the RO membrane. FIG. 7 shows an example of such a water treatment facility.

A water treatment facility 201 shown in FIG. 7 includes a raw water tank 202, a UF membrane device 203, an RO membrane device 204, and a permeated water tank 205. In addition, the water treatment facility 201 shown in FIG. 7 has a relay tank 206 and a decontamination filter 207 provided between the UF membrane device 203 and the RO membrane device 204. The reasons for the installations will be described later. The installations are connected by flow paths L202 to L204, L206, and L207, respectively. Furthermore, a supply path L209 is connected to the relay tank 206 to supply cleaning water to the primary side or secondary side of the UF membrane device 203.

The UF membrane device 203 is connected to an air supply system 210 that supplies air to the UF membrane device 203, as well as a cleaning water discharge system 211 that discharges the cleaning water after cleaning.

The flow paths L202, L206, and L207, and the supply path L209 are equipped with pumps P202, P206, P207, and P209, respectively. Among the pumps, the pumps P206 and P207 are designated as pressure pumps. The pumps P202 and P207 are equipped with VVVF inverter devices 216 and 217, respectively. In addition, the flow paths L203 and L204 are equipped with flow meters 226 and 227. The measurement results of the flow rates by the flow meters 226 and 227 are configured to be output to the VVVF inverter devices 216 and 217. The VVVF inverter devices 216 and 217 are configured to control the pumps P202 and P207 based on the measurement results of the flow rates.

n the water treatment facility 201 shown in FIG. 7, in response to cleaning the UF membrane of the UF membrane device 203, cleaning using air is performed, and in this case, air remains inside the UF membrane device 203. The cleaning using air is performed by supplying air to the UF membrane device 203 from the air supply system 210. In addition, simultaneously with the supply of air, UF membrane treated water may be sent from the relay tank 206 as cleaning water.

In response to restarting the production of pure water while air remains inside the UF membrane device 203, bubbles are contained in the treated water after passing through the UF membrane (hereinafter referred to as UF membrane treated water). In this case, if the UF membrane treated water containing bubbles is sent to the pump P207, the pump P207 may malfunction. Therefore, in the conventional water treatment facility 201, as mentioned earlier, the relay tank 206 and the decontamination filter 207 are provided. The relay tank 206 is designed as an open-type tank.

The relay tank 206 stores the UF membrane treated water that has passed through the UF membrane device 203. Since the relay tank 206 is designed as an open-type tank, the bubbles mixed in the UF membrane treated water are degassed in the relay tank 206. In addition, the relay tank 206 serves as a buffer to adjust the water supply volume to the RO membrane device 204.

On the other hand, due to the relay tank 206 being an open-type tank, foreign matter may enter the UF membrane treated water from the outside. Therefore, to prevent foreign matter from entering the RO membrane device 204, the decontamination filter 207 is provided.

As described above, in the conventional water treatment facility 201, it was needed to dispose the relay tank 206 and the decontamination filter 207 between the UF membrane device 203 and the RO membrane device 204, resulting in an increased number of equipment components and causing a problem of increased installation space for the water treatment facility 201. Especially in the case of disposing a portable water treatment facility 201 inside a building, the increase in installation space for the water treatment facility 201 had become a significant issue.

### RELATED ART

### Patent Literature

Patent Literature 1: International Publication No. WO 2020/194820

### SUMMARY

### Technical Problem

The present invention has been made in view of the above circumstances, and an objective is to provide a water treatment facility and a method for operating the same that are capable of reducing the installation space.

### Solution to the Problem

To solve the above problems, the present invention adopts the following configuration.

[1] A water treatment facility includes:
a first membrane filtration device;
a second membrane filtration device provided at a stage subsequent to the first membrane filtration device;
a reservoir tank in which a portion of permeated water that has permeated through the first membrane filtration device is stored;
a circulation flow path, provided between the first membrane filtration device and the reservoir tank, which enables the permeated water stored in the reservoir tank to circulate between the first membrane filtration device and the reservoir tank;
a pump included in the circulation flow path; and
a control section that controls the pump to circulate the permeated water stored in the reservoir tank between the first membrane filtration device and the reservoir tank through the circulation flow path after completion of filtration membrane cleaning involving air introduction to the first membrane filtration device.

[2] The water treatment facility according to [1] in which
the circulation flow path consists of
a first circulation flow path that supplies the permeated water that has permeated through the first membrane filtration device to the reservoir tank, and
a second circulation flow path that enables supply of the permeated water stored in the reservoir tank to a primary side of the first membrane filtration device, and
the pump is included in the second circulation flow path.

[3] The water treatment facility according to [1] or [2] in which the circulation flow path is a closed-type flow path, and the reservoir tank is an open-type reservoir tank.

[4] The water treatment facility according to [1] or [2] in which
the first membrane filtration device consists of multiple membrane filtration units connected in parallel to each other, and
the circulation flow path is configured to be capable of supplying the permeated water to each of the membrane filtration units, and
the control section circulates the permeated water stored in the reservoir tank between any one of the membrane filtration units and the reservoir tank through the circulation flow path.

[5] A method for operating a water treatment facility which includes a first membrane filtration device, a second membrane filtration device provided at a stage subsequent to the first membrane filtration device, and a reservoir tank in which a portion of permeated water that has permeated through the first membrane filtration device is stored, the method for operating the water treatment facility includes:
a water passage process in which the permeated water filtered by the first membrane filtration device is supplied to the second membrane filtration device; and
a cleaning process in which filtration membrane cleaning is performed on the first membrane filtration device during the water passage process, and
the cleaning process includes at least
an air cleaning stage in which filtration membrane cleaning using air is performed on the first membrane filtration device, and
an air release stage in which, after the air cleaning stage, the permeated water is circulated between the first membrane filtration device and the reservoir tank through a circulation flow path while allowing the permeated water to permeate from a primary side of the first membrane filtration device.

[6] The method for operating the water treatment facility according to [5] in which
the reservoir tank is an open-type reservoir tank, and
air discharged from the first membrane filtration device along with the permeated water in the air release process is degassed in the reservoir tank.

[7] The method for operating the water treatment facility according to [5] or [6] in which
the first membrane filtration device consists of multiple membrane filtration units connected in parallel to each other,
the circulation flow path is configured to be capable of supplying the permeated water to each of the membrane filtration units, and
the cleaning process is performed on a portion of the membrane filtration units among the membrane filtration units, and the water passage process is performed on the remaining membrane filtration units.

[8] The method for operating the water treatment facility according to [7] in which when the cleaning process is performed sequentially for the membrane filtration units, the water passage process is performed on all of the membrane filtration units between a preceding cleaning process for one membrane filtration unit and a subsequent cleaning process for another membrane filtration unit.

### Effects

The present invention can provide a water treatment facility and a method for operating the same that are capable of reducing the installation space.

### BRIEF DESCRIPTION OF THE DRAWINGS

FIG. 1 is a schematic diagram showing a water treatment facility according to an embodiment of the present invention.

FIG. 2 is a schematic diagram showing a first membrane filtration device included in the water treatment facility according to an embodiment of the present invention.

FIG. 3 is a schematic diagram showing the main parts of the first membrane filtration device.

FIG. 4A is a schematic diagram describing a method for operating the water treatment facility according to an embodiment of the present invention.

FIG. 4B is a schematic diagram describing a method for operating the water treatment facility according to an embodiment of the present invention.

FIG. 4C is a schematic diagram describing a method for operating the water treatment facility according to an embodiment of the present invention.

FIG. 4D is a schematic diagram describing a method for operating the water treatment facility according to an embodiment of the present invention.

FIG. 5A is a schematic diagram describing a method for operating the water treatment facility according to an embodiment of the present invention.

FIG. 5B is a schematic diagram describing a method for operating the water treatment facility according to an embodiment of the present invention.

FIG. 5C is a schematic diagram describing a method for operating the water treatment facility according to an embodiment of the present invention.

FIG. 5D is a schematic diagram describing a method for operating the water treatment facility according to an embodiment of the present invention.

FIG. 6A is a schematic diagram describing a method for operating the water treatment facility according to an embodiment of the present invention.

FIG. 6B is a schematic diagram describing a method for operating the water treatment facility according to an embodiment of the present invention.

FIG. 7 is a schematic diagram showing a conventional water treatment facility.

### DESCRIPTION OF EMBODIMENTS

A water treatment facility and a method for operating the same according to an embodiment of the present invention will be described with reference to the drawings.

A water treatment facility 100 of the embodiment includes: a first membrane filtration device 102; a second membrane filtration device 103 provided at a stage subsequent to the first membrane filtration device 102; a reservoir tank 105 in which a portion of permeated water that has permeated through the first membrane filtration device 102 is stored; a circulation flow path L110 that is provided between the first membrane filtration device 102 and the reservoir tank 105; a pump P3 that is provided in the circulation flow path L110; and a control section 110. In addition, a raw water tank 101 is provided at a stage prior to the first membrane filtration device 102. Furthermore, a treated water tank 104 is provided at a stage subsequent to the second membrane filtration device 103. Moreover, the water treatment facility 100 is provided with an air supply section 107 that supplies air to the first membrane filtration device 102, and a cleaning water discharge section 106 that discharges cleaning water from the first membrane filtration device 102.

In the water treatment facility 100 of the embodiment, the first membrane filtration device 102 filters raw water to produce primary permeated water, and the second membrane filtration device 103 filters the primary permeated water to produce secondary permeated water. A portion of the primary permeated water prepared by the first membrane filtration device 102 is temporarily stored in the reservoir tank 105. In response to performing a cleaning process for the first membrane filtration device 102, the primary permeated water is circulated between the first membrane filtration device 102 and the reservoir tank 105.

The various devices, flow paths, and auxiliary equipment that constitute the water treatment facility 100 will be described in detail below.

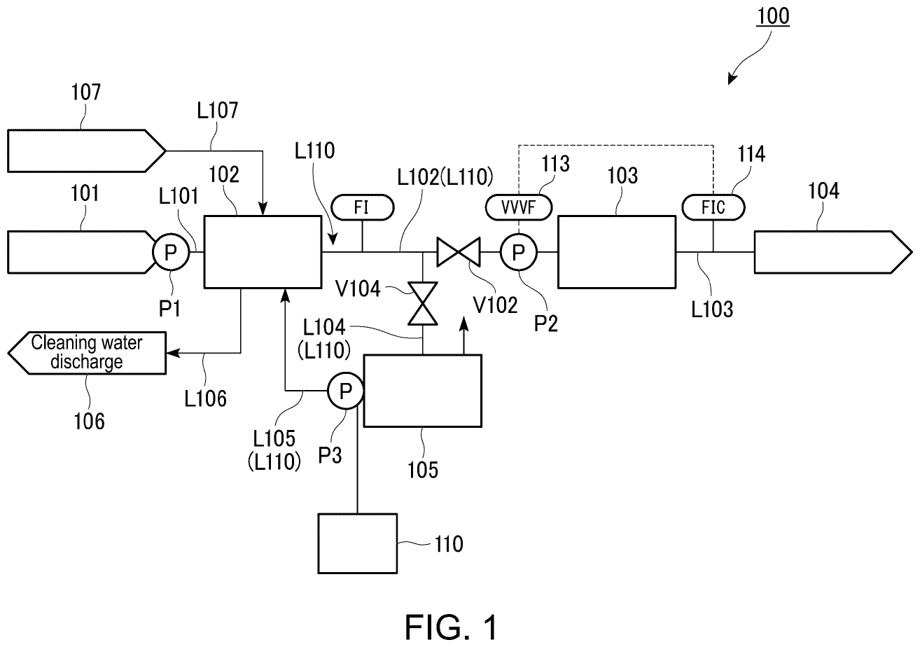

The water treatment facility 100 shown in FIG. 1 includes flow paths L101 to L107. The flow paths are of a closed type. The flow paths respectively interconnect the raw water tank 101, the first membrane filtration device 102, the second membrane filtration device 103, the treated water tank 104, the reservoir tank 105, the air supply section 107, and the cleaning water discharge section 106. In addition, valves V102 and V104 are provided in the flow paths L102 and L104, respectively.

The circulation flow path L110 consists of a first circulation flow path and a second circulation flow path. The first circulation flow path includes a portion of the flow path L102 and the flow path L104 branching from the flow path L102, and supplies a portion of the primary permeated water prepared by the first membrane filtration device 102 to the reservoir tank 105. The second circulation flow path consists of the flow path L105, and enables the supply of primary permeated water stored in the reservoir tank 105 to the primary side of the first membrane filtration device 102. The circulation flow path L110 further includes the reservoir tank 105. The pump P3 is provided in the flow path L105 (the second circulation flow path) to circulate the primary permeated water between the first membrane filtration device 102 and the reservoir tank 105. The circulation flow path L110 is a closed-type flow path.

In addition, as described later, the first membrane filtration device 102 consists of multiple membrane filtration units 102A and 102B connected in parallel to each other. For such a first membrane filtration device 102, the circulation flow path L110 is configured to be capable of supplying primary permeated water to each of the membrane filtration units 102A and 102B.

The flow paths L101 and L102 are equipped with pumps P1 and P2, respectively. The pump P1 pressurizes the raw water and supplies the raw water to the primary side of the first membrane filtration device 102. The pump P2 pressurizes the primary permeated water and supplies the primary permeated water to the primary side of the second membrane filtration device 103. The pump P2 is equipped with a VVVF inverter device 113. In addition, a flow meter 114 is provided in the flow path L103. The measurement results of the flow rate by the flow meter 114 are configured to be output to the VVVF inverter device 113. The VVVF inverter device 113 is configured to control the pump P2 based on the measurement results of the flow rate. This controls the water supply volume to the second membrane filtration device 103.

The reservoir tank 105 is where the primary permeated water prepared by the first membrane filtration device 102 is temporarily stored. The reservoir tank 105 forms a portion of the circulation flow path L110. The reservoir tank 105 is an open-type reservoir tank. As a result, in the operation method described later, when primary permeated water containing bubbles is circulated, the bubbles are degassed in the reservoir tank 105.

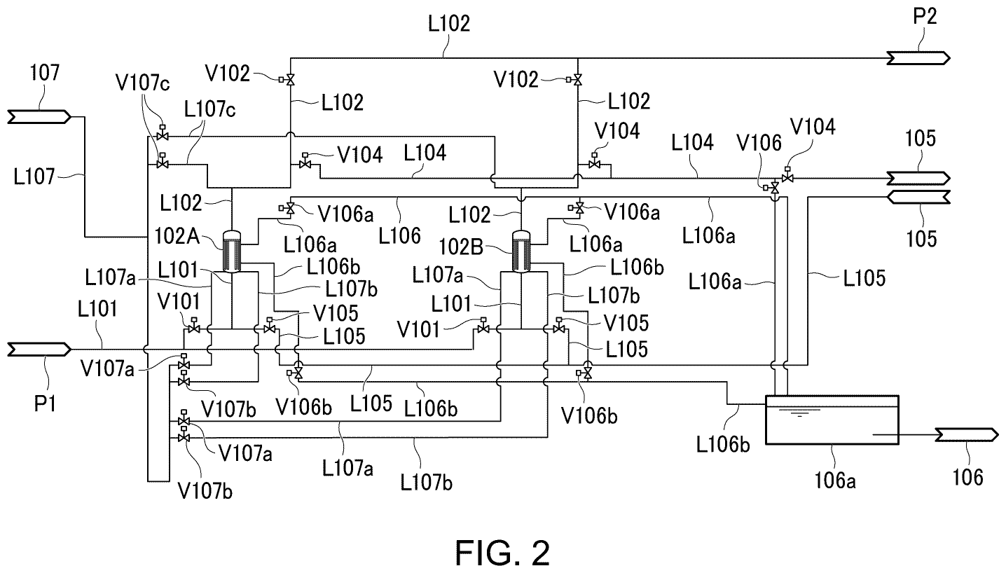

The first membrane filtration device 102, as shown in FIG. 2, consists of multiple membrane filtration units 102A and 102B connected in parallel to each other. FIG. 2 shows two membrane filtration units 102A and 102B, but the number of membrane filtration units is not limited to two, and may be three, four, or five or more units.

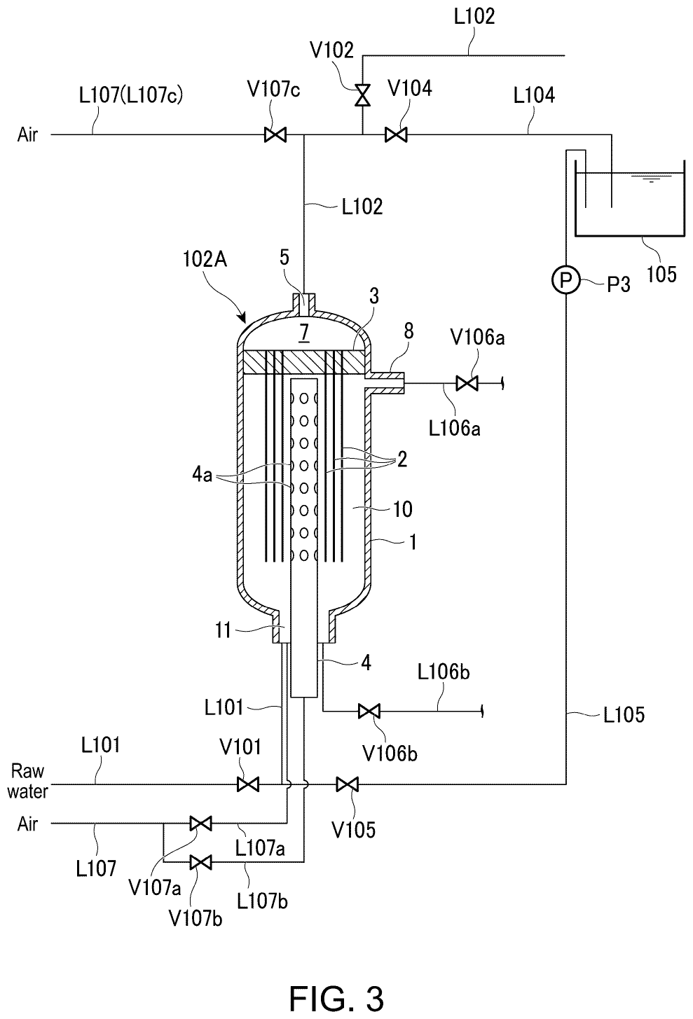

FIG. 3 shows an enlarged cross-sectional view of the membrane filtration unit 102A. The structure of the membrane filtration unit 102B is the same as the structure of the membrane filtration unit 102A. As shown in FIG. 3, the membrane filtration unit 102A includes a container 1 disposed with an axial direction of a cylinder in an up-down direction (in the embodiment, the vertical direction). Multiple hollow fiber membranes 2 are disposed inside the container 1.

The hollow fiber membranes 2 are fixed at the upper side of the container 1 by a synthetic resin potting section 3 serving as a fixing section, and are not fixed at the lower side of the container 1. For the synthetic resin of the potting section 3, epoxy resin can be used, for example. For instance, the hollow fiber membranes 2 are incorporated in a U-shaped configuration, and both ends of the hollow fiber membranes 2 are fixed by the potting section 3. In this case, the middle part of the hollow fiber membranes 2 is located at the lower part of the container 1.

The hollow fiber membranes 2 are, for example, ultrafiltration membranes (UF membranes). UF membranes can be exemplified as having pores of 0.005 to 0.5 μm. There are no particular restrictions on the hollow fiber membranes 2, but normally, hollow fiber membranes with an inner diameter of 0.2 to 1.0 mm, an outer diameter of 0.5 to 2.0 mm, and an effective length of about 300 to 2500 mm are used. There are also no particular restrictions on the membrane material of the UF membrane, but PVDF (polyvinylidene fluoride), polyethylene, polypropylene, and the like can be used. Further, the UF membrane provided in the first membrane filtration device 102 is not limited to a hollow fiber membrane, but may be a spiral membrane, a tubular membrane, or a flat membrane.

A treated water chamber (permeated water chamber) 7 and a raw water chamber 10 are partitioned and formed on the upper side and the lower side of the potting section 3, respectively. The upper end side of the hollow fiber membranes 2 penetrates through the potting section 3, and an opening at the upper end thereof faces the treated water chamber 7, with the interior of the hollow fiber membrane 2 communicating with the treated water chamber 7. In the case of incorporating the hollow fiber membranes 2 in a U-shaped configuration, both ends of the hollow fiber membranes 2 penetrate through the potting section 3. In addition, the raw water chamber 10 is designated as the primary side of the hollow fiber membranes 2, and the permeated water chamber 7 is designated as the secondary side of the hollow fiber membranes 2.

The potting section 3 is, for example, disc-shaped, and an outer circumferential surface or outer peripheral edge thereof is in watertight contact with the inner surface of the container 1.

In the interior (raw water chamber 10) of the container 1, a central pipe 4 extends in an approximately vertical direction (axial direction of the container 1). The central pipe 4 is, for example, disposed along the central axis of the container 1. The central pipe 4 is a circular pipe with a closed tip (upper end), and multiple ejection holes 4a are provided overall on the side circumferential surface thereof, spaced apart up and down and in the circumferential direction.

The height (length in the up-down direction) of the central pipe 4 is not particularly limited, but it is preferable that the upper end of the central pipe 4 is located near the lower surface of the potting section 3. It should be noted that the upper end of the central pipe 4 may be embedded in the potting section 3.

The following describes the connection state between the membrane filtration unit 102A and the flow paths L101, L102, L104 (first circulation flow path), L105 (second circulation flow path), L106 (L106a and L106b), and L107 (L107a and L107b). The connection state between the membrane filtration unit 102B and each of the flow paths is similar to that of the membrane filtration unit 102A.

The lower end of the central pipe 4 faces an opening 11 on the bottom surface of the container 1. The flow path L101 is connected to the opening 11, and a valve V101 is provided on the flow path L101. The flow path L105 merges with the flow path L101 on the container 1 side of the valve V101. The flow path L101 is connected to the raw water tank 101. In the water passage process, raw water is supplied from the raw water tank 101 to the interior (raw water chamber 10 (primary side)) of the container 1 through the flow path L101.

The flow path L105 (second circulation flow path) is connected to the reservoir tank 105. In the cleaning process of the first membrane filtration device 102, primary permeated water (permeated water) is supplied from the reservoir tank 105 to the interior (raw water chamber 10 (primary side)) of the container 1 through the flow path L105. The primary permeated water supplied to the raw water chamber 10 is filtered by the hollow fiber membranes 2 and sent out of the container 1 via the permeated water chamber 7.

By switching the opening and closing of the valve V101 and a valve V105, the supply of raw water/primary permeated water to the container 1 can be switched. By opening the valve V101, closing the valve V105, and sending out raw water through the flow path L101 using the pump P1, raw water can be supplied from the lower part of the raw water chamber 10. In addition, by closing the valve V101, opening the valve V105, and sending out primary permeated water through the flow path L105 using the pump P3, primary permeated water can be supplied from the lower part of the raw water chamber 10.

Furthermore, a flow path L107a is connected to the opening 11, and a valve V107a is provided on the flow path L107a. In addition, a flow path L107b is connected to the lower part of the central pipe 4, and a valve V107b is provided on the flow path L107b. The flow path L107a and the flow path L107b are branched from the flow path L107. The flow path L107 is connected to the air supply section 107. As a result, air is supplied from the air supply section 107 to the interior (raw water chamber 10) of the container 1 through the flow path L107 and the flow path L107a. Moreover, air is supplied to the central pipe 4 through the flow path L107 and the flow path L107b.

By switching the opening and closing of the valve V107a and the valve V107b, the supply route of air to the container 1 can be switched. By opening the valve V107a and closing the valve V107b, air can be supplied from the lower side of the interior (raw water chamber 10) of the container 1 through the opening 11. In addition, by closing the valve V107a and opening the valve V107b, air can be supplied from the upper side of the interior (raw water chamber 10) of the container 1 through the central pipe 4. Furthermore, in the case where the interior (raw water chamber 10) of the container 1 is filled with water, by supplying air from the flow path L107a or L107b, bubbles can be supplied from the opening 11 or the central pipe 4, enabling bubbling cleaning of the central fiber membranes 2.

Furthermore, an upper discharge outlet 8 is provided on the upper part of the side surface of the container 1. The upper discharge outlet 8 is provided near the lower surface of the potting section 3. A flow path L106a is connected to the upper discharge outlet 8, and a valve V106a is provided on the flow path L106a. In addition, a flow path L106b is connected to the opening 11, and a valve V106b is provided on the flow path L106b. The flow paths L106a and L106b converge to form the flow path L106, which is connected to a drainage tank 106a of the cleaning water discharge section 106. The cleaning wastewater or air from the interior (raw water chamber 10) of the container 1 is discharged through the flow paths L106a, L106b, and L106.

By switching the opening and closing of the valve V106a and the valve V106b, the discharge route for either or both of the cleaning wastewater and air from the container 1 can be switched. By opening the valve V106a and closing the valve V106b, either or both of the cleaning wastewater and air can be discharged from the upper side of the container 1 through the upper discharge outlet 8. In addition, by closing valve V106a and opening valve V106b, either or both of the cleaning wastewater and air can be discharged from the lower side of the container 1 through the opening 11. The cleaning wastewater is sent to the drainage tank 106a through the flow path L106.

An exit 5 for primary permeated water is provided at the top of the container 1. The flow path L102 is connected to the exit 5. The primary permeated water is extracted to the outside of the container 1 through the flow path L102 and sent to the second membrane filtration device 103. In addition, a flow path L107c branches off from the middle of the flow path L102. A valve V107c is provided on the flow path L107c. The flow path L107c is connected to the air supply section 107.

Furthermore, the flow path L104 branches off from the middle of the flow path L102. The valve V102 is provided on the flow path L102 downstream of the branching point, and the valve V104 is provided on the flow path L104. The flow path L104 is connected to the reservoir tank 105.

In the state where the valve V107c is closed, by switching the opening and closing of the valve V102 and the valve V104, the supply destination of the primary permeated water can be switched between the second membrane filtration device 103 and the reservoir tank 105. In the water passage process, by opening the valve V102 and closing the valve V104, the primary permeated water can be supplied to the second membrane filtration device 103. In addition, in the cleaning process, by closing the valve V102 and opening the valve V104, the primary permeated water can be supplied to the reservoir tank 105.

In addition, in the cleaning process, in the state where the valve V102 and the valve V104 are closed, by opening the valve V107c, air can be supplied to the interior (permeated water chamber 7) of the container 1 through the exit 5. This allows for air backwash of the central fiber membrane 2.

The flow path L102 needs to extend in the vertical direction for a certain length from the exit 5 at the top of the container 1. In addition, the exit 5 of the container 1 needs to be provided at the uppermost end of the container 1. In the operation method of the embodiment, in the air release process, it is needed to discharge the air remaining in the container 1 by circulating the primary permeated water. However, by extending the flow path L102 in the vertical direction for a certain length, the air may be discharged early from the container 1 towards the flow path L102 by the buoyancy of the air itself.

Next, the second membrane filtration device 103 shown in FIG. 1 prepares secondary permeated water by filtering the primary permeated water. The second membrane filtration device 103 includes a hollow fiber membrane. The hollow fiber membrane of the second membrane filtration device 103 is, for example, a reverse osmosis membrane (RO membrane). There is no particular restriction on the membrane material of the RO membrane, but cellulose acetate, aromatic polyamide, and the like can be used. Further, the RO membrane provided in the second membrane filtration device 103 is not limited to a hollow fiber membrane, but may be a spiral membrane or a tubular membrane.

The treatment tank 104 stores the secondary permeated water prepared by the second membrane filtration device 103.

The cleaning water discharge section 106 is where the cleaning wastewater generated in the cleaning process of the first membrane filtration device 102 is discharged. The first membrane filtration device 102 and the cleaning water discharge section 106 are connected by the flow path L106. As shown in FIG. 2, the cleaning water discharge section 106 includes a discharge tank 106a that temporarily stores the cleaning wastewater.

The air supply section 107 supplies air to the first membrane filtration device 102 in the cleaning process of the first membrane filtration device 102. The first membrane filtration device 102 and the air supply section 107 are connected by the flow path L107.

The control section 110 controls the pump P3 to circulate the primary permeated water stored in the reservoir tank 105 between the first membrane filtration device 102 and the reservoir tank 105 through the circulation flow path L110 after the completion of the filtration membrane cleaning involving air introduction to the first membrane filtration device 102. In addition, the control section 110 circulates the primary permeated water stored in the reservoir tank 105 between one of the membrane filtration unit 102A, the membrane filtration unit 102B, and the reservoir tank 105 through the circulation flow path L110.

Next, a method for operating the water treatment facility 100 of the embodiment will be described.

The method for operating the water treatment facility 100 of the embodiment includes a water passage process in which primary permeated water filtered by the first membrane filtration device 102 is supplied to the second membrane filtration device 103, and a cleaning process in which filtration membrane cleaning is performed on the first membrane filtration device 102 during the water passage process. The cleaning process includes at least an air cleaning stage and an air release stage. The air cleaning stage performs filtration membrane cleaning using air on the filtration membrane built into the first membrane filtration device 102. The air release stage, after the air cleaning stage, circulates the primary permeated water between the first membrane filtration device 102 and the reservoir tank 105 while allowing the primary permeated water to permeate through the filtration membrane from the primary side of the first membrane filtration device 102.

The details of the method for operating the water treatment facility 100 will be described below with reference to FIGS. 1 to 3. It should be noted that the opening and closing operations of valves and the operation and stopping of pumps described below are all performed according to instructions from the control section 110.

In the water passage process, as shown in FIG. 1, the pumps P1 and P2 are operated, the valve V102 is opened, and the valve V104 is closed. This allows raw water to be supplied from the raw water tank 101 to the first membrane filtration device 102 through the flow path L101. The raw water is filtered by the UF membrane (hollow fiber membrane 2) provided in the first membrane filtration device 102 to become primary permeated water. The primary permeated water is sent to the second membrane filtration device 103 through the flow path L102. At this time, the primary permeated water is sent to the second membrane filtration device 103 in a pressurized state by the pump P2 provided in the middle of the flow path L102. The primary permeated water is filtered by the RO membrane provided in the second membrane filtration device 103 to become secondary permeated water. The secondary permeated water is sent to the treatment tank 104 through the flow path L103.

The operation of the first membrane filtration device 102 during the water passage process will be described in detail with reference to FIGS. 2 to 4D.

In the water passage process, as shown in FIGS. 2 and 3, the valve V101 in the flow path L101 and the valve V102 in the flow path L102 are opened. On the other hand, the valve V105 in the flow path L105 (second circulation flow path) and the valve V104 in the flow path L104 (first circulation flow path) are closed. In addition, the valves V1107a to V107c in the flow path L107 are closed, and the valves V106a and V106b in the flow paths L106a and L106b are closed.

As a result, raw water is supplied to both of the membrane filtration units 102A and 102B through the flow path L101. The raw water is supplied to the raw water chamber 10 (primary side) of the container 1 and is filtered by the hollow fiber membrane 2 to become primary permeated water. The primary permeated water permeates through the hollow fiber membrane 2 and is extracted into the permeated water chamber 7 (secondary side) of the container 1. The primary permeated water is then sent to the second membrane filtration device 103 through the flow path L102.

By continuing the water passage process, suspended matter, organic matter, and the like (hereinafter referred to as suspended matter) contained in the raw water gradually accumulate on the primary side of the hollow fiber membrane 2. Therefore, to prevent clogging of the hollow fiber membrane 2, a cleaning process is performed.

The cleaning process is performed on any one of the multiple membrane filtration units 102A and 102B provided in the first membrane filtration device 102, while the water passage process is continued in the other membrane filtration unit. This allows the water passage process to be continued in parallel with the cleaning process, enabling the preparation of primary permeated water to continue without interruption. Even in cases where there are three or more membrane filtration units, the cleaning process may be performed on one membrane filtration unit while continuing the water passage process on the remaining units. In the following description, a case will be described in which the cleaning process is performed on the membrane filtration unit 102A, while the water passage process is continued on the membrane filtration unit 102B.

In the cleaning process of the embodiment, an air cleaning stage and an air release stage are performed sequentially.

In the air cleaning stage, filtration membrane cleaning is performed using air on the hollow fiber membrane 2 (filtration membrane) built into the first membrane filtration device 102. There are various types of filtration membrane cleaning using air. For example, air backwash that sends air from the secondary side of the hollow fiber membrane 2, air cleaning that supplies air to the primary side of the hollow fiber membrane 2 and cleans the hollow fiber membrane 2, and bubbling cleaning that cleans the hollow fiber membrane 2 by blowing air while the primary side of the hollow fiber membrane 2 is filled with water can be mentioned. In the air cleaning stage of the embodiment, as filtration membrane cleaning using air, any one of air backwash, air cleaning, or bubbling cleaning may be performed, or two or more of these may be performed. In addition, in the cleaning process, besides filtration membrane cleaning using air, water cleaning that supplies cleaning water to the primary side of the hollow fiber membrane 2 and cleans the hollow fiber membrane 2 may also be performed.

The following describes an example of the air cleaning stage with reference to FIGS. 2 to 5D. The example described below describes a case where air backwash, water cleaning, and bubbling cleaning are performed sequentially.

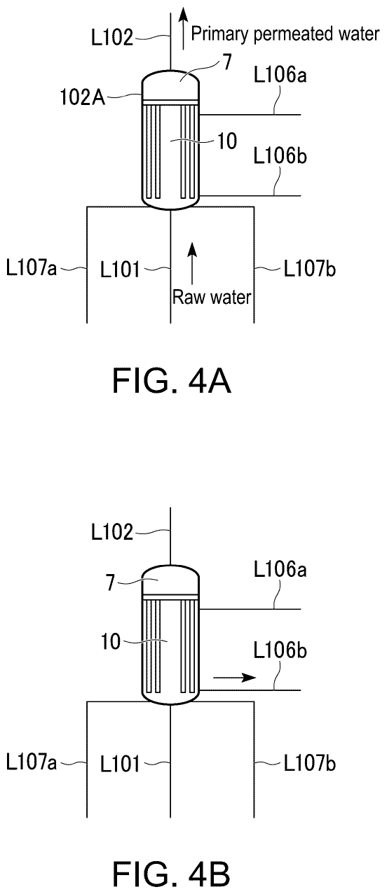

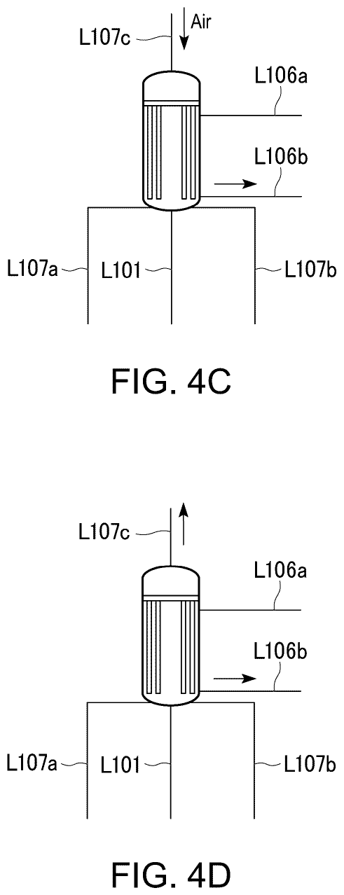

FIG. 4A shows the membrane filtration unit 102A in which the water passage process is continuing. Raw water is supplied to the raw water chamber 10 (primary side) through the flow path L101, filtered by the hollow fiber membrane 2, extracted as primary permeated water into the permeated water chamber 7 (secondary side), and discharged from the flow path L102. At this time, the valves V101 and V102 are opened, and the other valves are closed.

In addition, the valve opening and closing status in the other membrane filtration unit 102B is the same as in the case of the membrane filtration unit 102A. Hereafter, the cleaning process for the membrane filtration unit 102A will be described, but the valve opening and closing status in the membrane filtration unit 102B, in which the water passage process is continuing, will be maintained as is.

The following describes the air cleaning stage of the cleaning process for the membrane filtration unit 102A. First, the valve V101 of the flow path L101 is closed to stop the supply of raw water, and the valve V102 of the flow path L102 is also closed. In addition, the valve V106b of the flow path L106b is opened. As a result, as shown in FIG. 4B, the raw water that has been filled in the raw water chamber 10 (primary side) is discharged from the raw water chamber 10 through the flow path L106b. The discharged raw water is sent to the cleaning water discharge section 106.

Next, air backwash of the hollow fiber membrane 2 is performed. The valve V107c of the flow path L107c is opened. The valve V106b of the flow path L106b remains open. Then, as shown in FIG. 4C, air is supplied from the air supply section 107 to the permeated water chamber 7 (secondary side) through the flow paths L107c and L102, passed through the hollow fiber membrane 2, extracted into the raw water chamber 10 (primary side), and discharged from the flow path L106b. This allows air backwash of the hollow fiber membrane 2 to be performed.

Next, the supply of air from the air supply section 107 is stopped. As a result, as shown in FIG. 4D, the air pressure inside the permeated water chamber 7 and the raw water chamber 10 is reduced to atmospheric pressure.

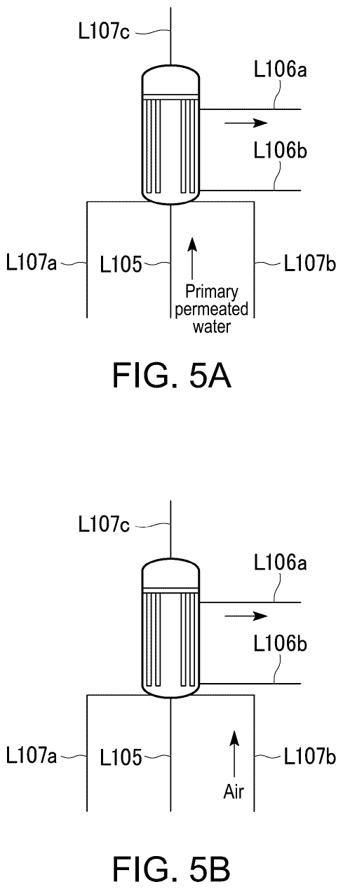

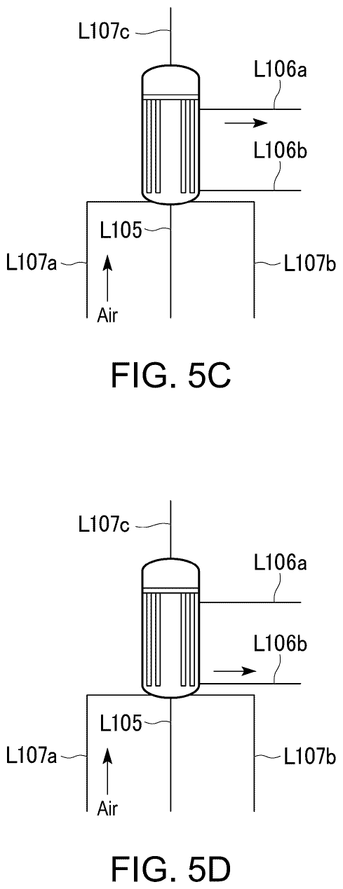

Next, primary permeated water is supplied to the primary side of the hollow fiber membrane 2, and water cleaning of the hollow fiber membrane 2 is performed. The valve V107c of the flow path L107c and the valve L106b of the flow path L106b are closed. The valve V105 of the flow path L105 and the valve V106a of the flow path L106a are opened. Then, the pump P3 is operated. As a result, as shown in FIG. 5A, primary permeated water is supplied from the reservoir tank 105 to the raw water chamber 10 (primary side), and the surface of the primary side of the hollow fiber membrane 2 is cleaned. The primary permeated water after cleaning is discharged from the flow path L106a as cleaning wastewater. By performing water cleaning, suspended matter that has accumulated on the surface of the primary side of the hollow fiber membrane 2 are removed.

Next, bubbling cleaning is performed on the primary side of the hollow fiber membrane 2. While keeping the raw water chamber 10 filled with primary permeated water, the valve V105 of the flow path L105 is closed. The pump P3 is stopped. The valve V107b of the flow path L107b is opened. The valve V106a of the flow path L106a remains open. As a result, as shown in FIG. 5B, air is supplied to the raw water chamber 10 (primary side) from the flow path L107b. The air is supplied from the flow path L107b to the central pipe 4, and is ejected into the raw water chamber 10 through the ejection holes 4a provided in the central pipe 4. Since the raw water chamber 10 remains filled with primary permeated water, the ejected air becomes bubbles and contacts the surface of the hollow fiber membrane 2 opposite to the central pipe 4, performing bubbling cleaning of the upper part of the hollow fiber membrane 2. The air used for cleaning is discharged from the flow path L106a along with a portion of the cleaning wastewater. In this way, the upper part of the hollow fiber membrane 2 is bubbling cleaned.

Next, bubbling cleaning continues to be performed on the primary side of the hollow fiber membrane 2. While keeping the raw water chamber 10 filled with primary permeated water, the valve V107b of the flow path L107b is closed. The valve V107a of the flow path L107a is opened. The valve V106a of the flow path L106a remains open. As a result, as shown in FIG. 5C, air is supplied to the raw water chamber 10 (primary side) from the flow path L107a. The air is supplied from the opening 11 at the bottom of the container 1. Since the raw water chamber 10 remains filled with primary permeated water, the supplied air becomes bubbles and contacts the surface of the primary side of the hollow fiber membrane 2, performing bubbling cleaning of the lower part of the hollow fiber membrane 2. The air used for cleaning is discharged from the flow path L106a. In this way, the lower part of the hollow fiber membrane 2 is bubbling cleaned.

Next, the valve V107a of the flow path L107a remains open, the valve V106a of the flow path L106a is closed, and the valve V106b of the flow path L106b is opened. As a result, as shown in FIG. 5D, while continuing the bubbling cleaning of the lower part of the hollow fiber membrane 2, the cleaning water in the raw water chamber 10 is discharged from the flow path L106b.

As described in FIGS. 5B to 5D, by changing the supply route of air, bubbling cleaning may be performed on the entire hollow fiber membrane 2.

Next, the air release stage is described. After the completion of the air cleaning stage, air remains inside the membrane filtration unit 102A of the first membrane filtration device 102. If the water passage process is resumed in this state, primary permeated water containing bubbles is sent to the pump P2 and the second membrane filtration device 103 through the flow path L102. This may cause abnormal operation of the pump P2 and the second membrane filtration device 103 due to the primary permeated water containing bubbles. Therefore, in the embodiment, an air release process is performed to completely remove bubbles from inside the membrane filtration unit 102A.

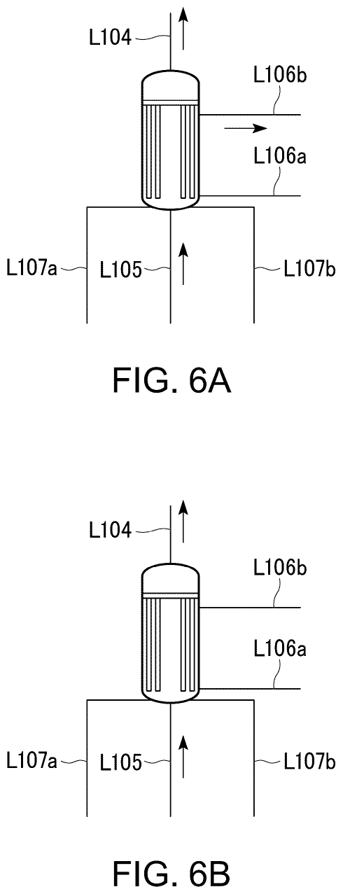

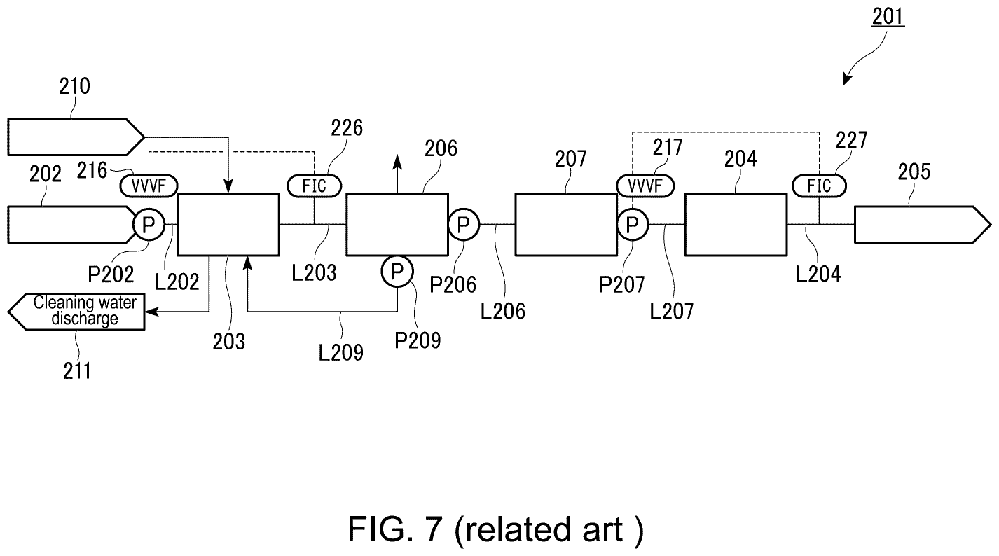

Specifically, first, the valve V104 of the flow path L104 (first circulation flow path) and the valve V105 of the flow path L105 (second circulation flow path) are opened. In addition, the valve V106a of the flow path L106a is opened. The valve V106b of the flow path L106b is closed, and the valve V1067a of the flow path L107a is also closed. Then, the pump P3 is operated. As a result, as shown in FIG. 6A, primary permeated water is supplied from the reservoir tank 105 to the raw water chamber 10 (primary side). A portion of the primary permeated water is discharged from the flow path L106b. The discharged primary permeated water is sent to the cleaning water discharge section 106. This allows for early discharge of the air remaining in the raw water chamber 10 (primary side) and filling of the raw water chamber 10 with primary permeated water.

In addition, the remaining portion of the primary permeated water supplied to the raw water chamber 10 (primary side) permeates through the hollow fiber membrane 2 and is extracted from the permeated water chamber 7 (secondary side). The extracted primary permeated water is returned to the reservoir tank 105 via the flow path L104. The returned primary permeated water is sent back to the membrane filtration unit 102A via the flow path L105. In this way, the circulation of primary permeated water through the circulation flow path is stabilized.

Next, the valve V106a of the flow path L106a is closed. The valve V104 of the flow path L104 (first circulation flow path) and the valve V105 of the flow path L105 (second circulation flow path) remain open, and the pump P3 remains to be operated. As a result, as shown in FIG. 6B, the primary permeated water stored in the reservoir tank 105 is circulated between the reservoir tank 105 and the membrane filtration unit 102A through the circulation flow path L110.

The circulation of primary permeated water generates a water flow of the primary permeated water inside the container 1 of the membrane filtration unit 102A, and the bubbles remaining inside the container 1 are discharged from the exit 5 of the container 1 to the flow path L102 by the water flow. Here, the flow path L102 extends in the vertical direction for a certain length from the exit 5 at the top of the container 1, and the exit 5 of the container 1 is provided at the uppermost end of the container 1, so the bubbles remaining inside the container 1 may be discharged to the outside of the container 1 at an early stage due to the buoyancy of the air itself.

The discharged bubbles, along with the primary permeated water, are sent to the reservoir tank 105 via the flow path L104. Since the reservoir tank 105 is of an open type, the bubbles that reach the reservoir tank 105 are immediately degassed.

In this way, the air introduced into the interior of the membrane filtration unit 102A during the air cleaning stage may almost be completely discharged by means of the air release stage.

After the completion of the cleaning process, it is preferable for the membrane filtration unit 102A to promptly transition to the water passage process.

In addition, the cleaning process may be performed sequentially for multiple membrane filtration units. In other words, it is of course acceptable to start the cleaning process for another membrane filtration unit 102B after the completion of the cleaning process for the membrane filtration unit 102A. However, if the cleaning process for another membrane filtration unit 102B is started immediately after the completion of the cleaning process for the membrane filtration unit 102A, the supply volume of primary permeated water may fluctuate significantly, potentially disrupting the balance between the supply volume of primary permeated water and the production volume of secondary permeated water in the second membrane filtration device 103, which may lead to unstable operation of the second membrane filtration device 103.

Therefore, in the case where the cleaning process is performed sequentially for multiple membrane filtration units, it is preferable to perform the water passage process for all membrane filtration units between the preceding cleaning process for one membrane filtration unit and the subsequent cleaning process for another membrane filtration unit. In other words, it is advisable to start the cleaning process for the membrane filtration unit 102B after the cleaning process for the membrane filtration unit 102A has ended and the membrane filtration unit 102A has transitioned to the water passage process. When the membrane filtration unit 102A transitions to the water passage process, the water passage process is also in progress in the membrane filtration unit 102B. In this manner, it is preferable to perform the next cleaning process after all membrane filtration units have once transitioned to the water passage process.

As described above, according to the water treatment facility 100 of the embodiment, since the water treatment facility 100 includes the circulation flow path L110 that enables circulation of the primary permeated water stored in the reservoir tank 105 between the first membrane filtration device 102 and the reservoir tank 105, the pump P3, and the control section 110, bubbles remaining in the first membrane filtration device 102 can be removed early even when filtration membrane cleaning involving air introduction to the first membrane filtration device 102 is performed. Furthermore, compared to the conventional water treatment facility, the number of equipment components can be significantly reduced, allowing for the water treatment facility 100 to be made compact.

Moreover, since the circulation flow path L110 is composed of the first circulation flow path that supplies the primary permeated water to the reservoir tank 105 and the second circulation flow path that enables the supply of the primary permeated water stored in the reservoir tank 105 to the first membrane filtration device 102, the circulation route of the primary permeated water becomes shorter, allowing the water treatment facility 100 to be made compact.

Furthermore, since the reservoir tank 105 is an open-type reservoir tank, bubbles contained in the primary permeated water can be released in the reservoir tank 105. In addition, since the circulation flow path L110 is a closed-type flow path, the introduction of bubbles from the outside can be suppressed.

Furthermore, the first membrane filtration device 102 is composed of multiple membrane filtration units 102A and 102B connected in parallel to each other, and the circulation flow path L110 is configured to be capable of supplying the primary permeated water to each of the membrane filtration units 102A and 102B. In addition, the control section 110 circulates the primary permeated water stored in the reservoir tank 105 between any one of the membrane filtration units and the reservoir tank 105 through the circulation flow path L110. Therefore, even if one membrane filtration unit is in the cleaning process, the water passage process can be continued in the other membrane filtration unit, thus the production volume of secondary permeated water is not reduced.

According to the method for operating the water treatment facility of the embodiment, the method includes a cleaning process in which filtration membrane cleaning is performed on the first membrane filtration device 102 during the water passage process. The cleaning process includes at least an air cleaning stage in which filtration membrane cleaning using air is performed on the first membrane filtration device 102, and an air release stage after the air cleaning stage, in which primary permeated water is circulated between the first membrane filtration device 102 and the reservoir tank 105 while allowing the primary permeated water to permeate from the primary side of the first membrane filtration device 102. Therefore, even if air remains as bubbles in the first membrane filtration device 102 after the air cleaning stage, the remaining bubbles can be removed early by the air release stage.

Furthermore, since the reservoir tank 105 is an open-type reservoir tank, bubbles contained in the primary permeated water can be released in the reservoir tank 105.

Furthermore, the first membrane filtration device 102 is composed of multiple membrane filtration units 102A and 102B connected in parallel to each other, and the circulation flow path L110 is configured to be capable of supplying the primary permeated water to each of the membrane filtration units 102A and 102B. Among the membrane filtration units, the cleaning process is performed on a portion of the membrane filtration unit 102A, and the water passage process is performed on the remaining membrane filtration unit 102B. Therefore, the production volume of secondary permeated water is not reduced.

Furthermore, in the case where the cleaning process is performed sequentially for multiple membrane filtration units, the water passage process is performed on all of the membrane filtration units 102A and 102B between the preceding cleaning process for the membrane filtration unit 102A and the subsequent cleaning process for the membrane filtration unit 102B. As a result, the balance between the supply volume of the primary permeated water to the second membrane filtration device 103 and the production volume of secondary permeated water is maintained within an appropriate range, allowing stable operation of the entire water treatment facility 100.

### INDUSTRIAL APPLICABILITY

As described above, the present invention can provide a water treatment facility and a method for operating the same that are capable of reducing the installation space.

### REFERENCE SIGNS LIST

100 . . . water treatment facility; 101 . . . raw water tank; 102 . . . first membrane filtration device; 102A, 102B . . . membrane filtration unit; 103 . . . second membrane filtration device; 104 . . . treated water tank; 105 . . . reservoir tank; L110 . . . circulation flow path; P3 . . . pump; 110 control section; L102, L104 . . . first circulation flow path; L105 . . . second circulation flow path.

1. A water treatment facility, comprising:
a first membrane filtration device;
a second membrane filtration device, provided at a stage subsequent to the first membrane filtration device;
a reservoir tank, in which a portion of permeated water that has permeated through the first membrane filtration device is stored;
a circulation flow path, provided between the first membrane filtration device and the reservoir tank, and enabling the permeated water stored in the reservoir tank to circulate between the first membrane filtration device and the reservoir tank;
a pump, comprised in the circulation flow path; and
a control section, controlling the pump to circulate the permeated water stored in the reservoir tank between the first membrane filtration device and the reservoir tank through the circulation flow path after completion of filtration membrane cleaning involving air introduction to the first membrane filtration device.

2. The water treatment facility according to claim 1, wherein
the circulation flow path consists of
a first circulation flow path that supplies the permeated water that has permeated through the first membrane filtration device to the reservoir tank, and
a second circulation flow path that enables supply of the permeated water stored in the reservoir tank to a primary side of the first membrane filtration device, and
the pump comprised in the second circulation flow path.

3. The water treatment facility according to claim 1, wherein the circulation flow path is a closed-type flow path, and the reservoir tank is an open-type reservoir tank.

4. The water treatment facility according to claim 1, wherein
the first membrane filtration device consists of a plurality of membrane filtration units connected in parallel to each other, and
the circulation flow path is configured to be capable of supplying the permeated water to each of the plurality of membrane filtration units, and
the control section circulates the permeated water stored in the reservoir tank between any one of the membrane filtration units and the reservoir tank through the circulation flow path.

5. A method for operating a water treatment facility which comprises a first membrane filtration device, a second membrane filtration device provided at a stage subsequent to the first membrane filtration device, and a reservoir tank in which a portion of permeated water that has permeated through the first membrane filtration device is stored, the method for operating the water treatment facility comprising:
a water passage process of supplying the permeated water filtered by the first membrane filtration device to the second membrane filtration device; and
a cleaning process of performing filtration membrane cleaning on the first membrane filtration device during the water passage process, and
the cleaning process comprising at least
an air cleaning stage of performing filtration membrane cleaning using air on the first membrane filtration device, and
an air release stage of, after the air cleaning stage, circulating the permeated water between the first membrane filtration device and the reservoir tank through a circulation flow path while allowing the permeated water to permeate from a primary side of the first membrane filtration device.

6. The method for operating the water treatment facility according to claim 5, wherein
the reservoir tank is an open-type reservoir tank, and
air discharged from the first membrane filtration device along with the permeated water in the air release process is degassed in the reservoir tank.

7. The method for operating the water treatment facility according to claim 5, wherein
the first membrane filtration device consists of a plurality of membrane filtration units connected in parallel to each other,
the circulation flow path is configured to be capable of supplying the permeated water to each of the plurality of membrane filtration units, and
the cleaning process is performed on a portion of the membrane filtration units among the plurality of membrane filtration units, and the water passage process is performed on the remaining membrane filtration units.

8. The method for operating the water treatment facility according to claim 7, wherein when the cleaning process is performed sequentially for the plurality of membrane filtration units, the water passage process is performed on all of the membrane filtration units between a preceding cleaning process for one membrane filtration unit and a subsequent cleaning process for another membrane filtration unit.
